(19) United States
(12) Patent Application Publication
(10) Pub. No.: US 2025/0250439 A1
(43) Pub. Date: Aug. 7, 2025

(54) INJECTION MOLDABLE COMPOSITIONS AND ARTICLES COMPRISING SAME

(71) Applicant: BIOPLASMAR LTD., Moshav Aderet (IL)

(72) Inventors: Chanoch SAMET, Moshav Aderet (IL); Martin UBL, Moshav Aderet (IL); Benjamin UBL, Bergen (DE)

(73) Assignee: BIOPLASMAR LTD., Moshav Aderet (IL)

(21) Appl. No.: 18/857,428

(22) PCT Filed: Apr. 19, 2023
(86) PCT No.: PCT/IL2023/050406

§ 371 Date: Oct. 16, 2024

Related U.S. Application Data
(60) Provisional application No. 63/332,297, filed on Apr. 19, 2022.
(60) Provisional application No. 63/445,337, filed on Feb. 14, 2023.

(51) Int. Cl. C08L 97/02; A01G 9/02; A01G 9/029; A47G 19/03; B29C 45/00; B29K 67/00; B29K 105/00; B29K 509/02; B29K 511/14; B29L 31/00; C08L 67/02

(52) U.S. Cl. CPC C08L 97/02; A01G 9/021; A01G 9/0291; A47G 19/03; B29C 45/0001; C08L 67/02; B29K 2003/00; B29K 2067/00; B29K 2105/0085; B29K 2509/02; B29K 2511/14; B29K 2995/006; B29L 2031/712; B29L 2031/7132; B29L 2031/7136; C08L 2201/06; C08L 2203/30; C08L 2207/20

(57) ABSTRACT

In one aspect, there is provided a composition comprising a waste particulate material and a biodegradable polymer; wherein the biodegradable polymer comprises a thermoplastic polymer; a weight portion of said biodegradable polymer within said composition is between 10 and 50%; and wherein said composition is flowable at a temperature between 100 and 220° C.. Furthermore, shaped articles derived from the composition and method of manufacturing thereof are also provided.

### CROSS REFERENCE TO RELATED APPLICATIONS

This application claims the benefit of priority of U.S. Provisional Patent Application Nos. 63/332,297, filed on Apr. 19, 2022, and 63/445,337, filed on Feb. 14, 2023, both entitled: INJECTION MOLDABLE COMPOSITIONS AND ARTICLES COMPRISING SAME, the contents of which are all incorporated herein by reference in their entirety.

### FIELD OF THE INVENTION

The invention relates to the field of mixtures used in the preparation of biodegradable articles, biodegradable containers and articles for disposable use and to methods for manufacturing biodegradable articles, such as by injection molding.

### BACKGROUND OF THE INVENTION

A major source of preoccupation in modern society has been the amount of waste produced and its impact on the environment, increasing pollution and using valuable spaces as landfill. Thus, there has been great interest in the manufacture of biodegradable disposable articles, and especially when these are made from recycled or discarded material.

One application for biodegradable disposable containers is in the agricultural sector, for example in plant nurseries and green houses. Plants are grown in pots until they are mature enough to be distributed to retail outlets or to consumers. Typically, molded non-biodegradable plastic pots are used for growing plants, which end up being discarded after the plant is transplanted into the soil. The pots then end up in landfills or garbage dumps, where they remain for a very long time since they are not biodegradable.

Alternatives to conventional plastic pots exist. Biodegradable pots made of paper (cellulose fibers), peat and other organic waste are known. These pots are designed to degrade relatively quickly when buried in soil. This allows consumers to simply bury the pot with the plant in it, rather than having to remove the plant from the pot before planting. However, the biodegradable pots must also be substantially resistant to irrigation and to greenhouse conditions during the growing period, so as to prevent disintegration thereof prior to being buried in soil.

Some biodegradable pots include a thermoplastic polymer layer on top of the interior surface of the plant pot, which is exposed to soil placed in the plant pot. However, methods of irrigation and the humid environment in many nurseries cause the external surfaces of pots to be exposed to moisture, so that a sealant on the interior of a plant pot does not prevent degradation of the pot while still on the shelf in the nursery (or greenhouse).

Exemplary biodegradable articles, such as plant pots disclosed in PCT/IL2021/050498, are currently manufactured by hot press molding, which is costly and incompatible with commercial mass production of said articles. Accordingly, there is a need for flowable, and cost-effective compositions solely based on degradable and/or compostable constituents, which are suitable for processing via injection molding.

### SUMMARY OF THE INVENTION

It is an object of the present invention to provide a flowable composition derived from organic waste, which is used in the manufacture of biodegradable containers and articles, in particular by means of thermoplastic polymer processing.

In one aspect, the present invention provides a composition comprising a waste particulate material and a biodegradable polymer; wherein the biodegradable polymer is or comprises a thermoplastic polymer; a weight portion of said biodegradable polymer within said composition is between about 10 and about 50%; and wherein said composition is flowable at a temperature between 10° and 250° C.

In one embodiment, the composition further comprises between 0.5 and 10% w/w of a gliding agent, and wherein said composition is in a form of a composite material.

In one embodiment, the composition is a thermoplastic material or a thermoplastic composite material.

In one embodiment, the composition is characterized by a moisture content of less than 0.5%.

In one embodiment, the biodegradable polymer is characterized by a melt flow index (MFI) between 30 and 80.

In one embodiment, the biodegradable polymer comprises a polyester, polyaminoacid a thermoplastic polysaccharide derivative, thermoplastic starch, including any copolymer or any mixture thereof.

In one embodiment, the polyester is selected from poly(butylene adipate-co-terephthalate) (PBAT), poly(butylene succinate-co-adipate) (PBSA), PLA, PLGA, PGA, a, including any copolymer or any mixture thereof.

In one embodiment, the waste particulate material is an organic waste particulate material selected from wood chips, soil, saw dust, compost, biomass, and ash, or any combination thereof; and wherein the waste particulate material is characterized by an average particle size between 1 and 4 mm.

In one embodiment, gliding agent comprises a clay mineral (e.g., talc), a wax, glycerol, glycol, a fatty acid including any ester thereof (such as mono-, di or tri-glyceride), or any combination thereof.

In one embodiment, a weight portion of said biodegradable polymer within said composition is between 15 and 30%, a weight portion of said gliding agent within said composition is between 1 and 5%, and wherein the biodegradable polymer is or comprises PBAT.

In another aspect, there is provided an article comprising at least one wall, wherein the wall comprises the composition of the invention, and wherein the article is biodegradable or bioerodible (or compostable).

In one embodiment, the article is substantially degradable in soil within a predetermined time period ranging between 2 days and 10 weeks.

In one embodiment, the wall is characterized by a wall thickness of between 1 and 5 mm.

In one embodiment, the article is in a form of a container.

In one embodiment, the article is in a form of a planting article (e.g. a plant pot, a plug tray), or a dishware.

In one embodiment, the article is stable under greenhouse conditions for a predefined time period ranging between 3 days and 10 months.

In another aspect, there is provided a method of manufacturing the invention, the method comprises providing the composition of the invention under suitable conditions thereby obtaining a shapeable composition; and processing said shapeable composition to obtain the article with a predetermined shape.

In one embodiment, suitable conditions are sufficient for inducing flowability of said composition.

In one embodiment, processing comprises molding of said shapeable composition.

In one embodiment, suitable conditions comprise a pressure between 500 and 5000 bar, and a temperature between 10° and 250° C.

In one embodiment, the method is performed by injection molding.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

In addition to the exemplary aspects and embodiments described above, further aspects and embodiments will become apparent by reference to the study of the following detailed description.

### BRIEF DESCRIPTION OF THE FIGURES

FIG. 1 is a schematic illustration of a plant pot manufactured with the mixture according to one embodiment of the invention;

FIGS. 2A and 2B are schematic illustrations of a biodegradable trays according to embodiments of the invention; and

FIGS. 3A and 3B are images of exemplary articles of the invention such as plant pots (3A) and dish ware (3B), manufactured by injection molding.

FIG. 4 is a schematic illustration of a plant pot comprising side openings and is manufactured according to one embodiment of the invention.

### DETAILED DESCRIPTION OF THE INVENTION

The present invention is related, in some embodiments thereof, to a composition comprising organic material (e.g., a waste organic material with an average particle size below 4 mm, below 3 mm, or below 2 mm) and a thermoplastic polymer. In one embodiment, the composition further comprising an additive, such as a gliding agent, water absorbing agent, a colorant, or any combination thereof. In one embodiment, the composition is flowable under conditions described herein. In one embodiment, the thermoplastic polymeric induces processability of the composition by means of thermoplastic polymer processing (e.g., injection molding, extrusion, etc.) and further provides sufficient mechanical stability and optionally water impermeability to the biodegradable and/or bio erodible articles of the invention process from the composition described herein.

The compositions and articles of some aspects described herein, have been optimized for use in cultivation of annual and/or perennial crop plants, trees, and/or ornamental plants, including any combination thereof.

In one aspect, the present invention provides at least an article including but not limited to plant pots, and other containers (e.g., planting articles, dish ware, etc.), being partially degradable or biodegradable, for use in agriculture, the article comprise biomass (such as wood-waste and/or soil) and a thermoplastic polymer. In one embodiment, the article of the invention is selected from a biodegradable article, a bio erodible article, a compostable article, and a recyclable article including any combination thereof. In one embodiment, the article of the invention is substantially stable to various irrigation techniques under greenhouse conditions for a predefined period of between 3 days and 10 months.

In some embodiments, the article of the invention is configured to retain at least 80%, at least 90%, at least 95% of the geometrical shape and/or physical properties thereof under greenhouse conditions and is further configured to undergo a gradual degradation or erosion upon contact thereof with soil (e.g. by planting in an open field). In some embodiments, the article of the invention is characterized by a degradation profile adopted for cultivation of annual plants and/or perennial plants. In some embodiments, the article of the invention is configured to support growth of a young plant in a soil, thus preventing mechanical or biological damage (e.g. by a pest) to the plant roots on and post planting; and to facilitate plant roots growth (or breakthrough) through a wall of the article. In some embodiments, the article of the invention comprising a cultured plant is configured to substantially retain its function as a container (e.g. by at least partially retaining its geometrical shape so as to enclose at least 80% of the plant roots) upon transplanting thereof into the soil, for a time period sufficient for acclimatization of the plant within the soil.

In one embodiment, an exemplary planting article of the invention is or comprises a biodegradable or compostable plant pot, being characterized by enhanced stability under normal storage conditions and is configured to undergo biodegradation and/or bio erosion in-situ at a planting site (e.g. soil) within a predefined time period.

One major advantage of the container manufactured from the composition of the invention is its decomposition/erosion and integration with the soil organic matter, after its role as a container ends. In some embodiments, the composition of the invention is a shapeable and/or a flowable composition, suitable for manufacturing of an exemplary article of the invention by an industrial molding process (e.g. injection molding). In some embodiments, the composition of the invention is flowable under suitable conditions described herein, wherein the flowable composition is characterized by rheological properties sufficient for shaping or manufacturing of an exemplary article of the invention by an industrial molding process (e.g. injection molding, and/or extrusion). In some embodiments, the article of the invention described herein is substantially water impermeable, thus being suitable for use thereof as a dishware.

### Flowable Composition

In one aspect of the present invention, provided herein a composition comprising an organic waste component (also used herein as the “waste particulate material”) and a biodegradable polymer; wherein the biodegradable polymer is or comprises a thermoplastic polymer; wherein a weight portion of the biodegradable polymer within the composition is between 10 and 50%, and wherein the composition is flowable or shapeable under suitable conditions comprising a temperature between 10° and 250° C. or between 10° and 220° C. and optionally comprises pressure (e.g. a pressure between 500 and 5000 bar).

The terms “organic waste component”, “waste particulate material”, and “organic waste particulate material” are used herein interchangeably.

In some embodiments, the term “suitable conditions” encompasses conditions suitable for an industrial hot melt process of shaping articles such as molding (e.g. injection molding, or injection compression molding), and/or extrusion. In some embodiments, the flowability of the composition at a temperature ranging between 10° and 250° C. is sufficient for shaping of the composition via an industrial hot melt apparatus, such as an extruder, or an injection molding machine. As killed artisan will appreciate that a composition suitable for injection molding is flowable under application of a sufficient compression force to the composition, along with heating the composition at the temperature range describe hereinabove. The composition suitable for injection molding maintains its chemical structure (i.e. doesn't decompose) under conditions suitable for injection molding.

In another aspect of the present invention, there is provided herein a composition comprising the organic waste component (e.g., saw dust, wood chips, and/or compost); between 10 and 50% w/w of the biodegradable polymer, and further comprising a gliding agent.

In some embodiments, the composition of the invention comprises at least one organic waste component characterized by a particle size of between 1 and 4 mm including any range between. In some embodiments, the composition of the invention is a solid at a temperature below the glass transition point of the biodegradable polymer, or below the melting or liquification point of the biodegradable polymer. In some embodiments, the composition of the invention is a solid at a temperature up to 100° C., up to 120° C., up to 140° C., including any range between.

In some embodiments, the composition of the invention comprises (i) an organic waste component selected from compost and at least one of wood chips, bark dust, saw dust, and compost, wherein the organic waste component is characterized by a particle size of between 1 and 4 mm including any range between; (ii) at least one biodegradable polymer characterized by a melt flow index (MFI) between 30 and 80; and (iii) optionally between 0.5 and 10% w/w of a gliding agent (also known as a slipping agent); wherein a w/w concentration of the biodegradable polymer within the composition is at least 10%, at least 15%, at least 17%, at least 20%, at least 25%, or at least 30% including any range between; and wherein said composition is characterized by a moisture content of less than 1%, less than 0.7%, less than 0.6%, less than 0.5%, less than 0.4%, less than 0.3%, including any range between.

In some embodiments, a w/w concentration of the biodegradable polymer of the invention within the composition of the invention is between 10 and 50, between 15 and 50, between 10 and 40, between 15 and 40, between 10 and 30, between 15 and 30, between 10 and 20, between 20 and 50, between 20 and 40, between 20 and 30, including any range therebetween. Without being bound to any particular theory or mechanism, it is postulated that a w/w concentration of the polymer of the invention being of at least 10%, at least 15%, at least 20%, at least 25%, at least 30% from the total weight of the composition of the invention, is sufficient for obtaining a flowable composition, suitable for shaping by means of thermoplastic polymer processing.

The inventors successfully manufactured exemplary biodegradable articles of the invention comprising about 30% by weight of the thermoplastic biodegradable polymer of the invention (such as PBAT, and/or thermoplastic starch) via injection molding. The resulting articles were characterized by sufficient stability and exhibited a predetermined degradation profile in soil. It is presumed, that the degradation profile of the articles can be modified by (i) varying the concentration of the biodegradable polymer; (ii) varying the composition of the organic waste component; and/or by (iii) introducing an disintegrant (such as a water absorbing material) into the composition of the invention.

In some embodiments, the composition of the invention comprises one or more biodegradable polymers. In some embodiments, the biodegradable polymer is or comprises a thermoplastic polymer. In some embodiments, the biodegradable polymer is characterized by MFI ranging between 20 and 100, between 50 and 100, between 30 and 80, between 40 and 80, between 50 and 80, between 60 and 80, between 50 and 75, between 50 and 80, between 60 and 75, between 60 and 100, between 60 and 90, between 50 and 90, between 70 and 80, between 70 and 75, including any range between.

In some embodiments, the composition of the invention is characterized by MFI ranging between 20 and 100, between 50 and 100, between 30 and 80, between 40 and 80, between 50 and 80, between 60 and 80, between 50 and 75, between 50 and 80, between 60 and 75, between 60 and 100, between 60 and 90, between 50 and 90, between 70 and 80, between 70 and 75, including any range between.

In some embodiments, the biodegradable polymer is a thermoplastic polymer and is characterized by a melting point or a liquification point between 8° and 250° C., between 8° and 150° C., between 10° and 220° C., between 12° and 220° C., between 14° and 220° C., between 100 and 180° C., between 8° and 180° C., between 10° and 170° C., between 120 and 170° C., including any range between. As used herein, the terms “thermoplastic biodegradable polymer”, “thermoplastic polymer”, and “biodegradable polymer” are used herein interchangeably.

In some embodiments, the composition of the invention and/or the article of the invention is a thermoplastic material. In some embodiments, the composition of the invention and/or the article of the invention is characterized by a melting point or a liquification point between 8° and 250° C., between 8° and 150° C., between 10° and 220° C., between 12° and 220° C., between 14° and 220° C., between 10° and 180° C., between 8° and 180° C., between 100 and 170° C., between 12° and 170° C., including any range between.

In some embodiments, the biodegradable polymer is or comprises a biocompatible thermoplastic polymer. In some embodiments, the thermoplastic polymer comprises a biocompatible and/or biodegradable polymer.

In some embodiments, the biodegradable polymer comprises any one of: a polyester, a polyaminoacid, PVA, PVP, PEG, a thermoplastic polysaccharide derivative, a thermoplastic starch (e.g. Matter-Bi), including any copolymer or any mixture thereof. In some embodiments, the polyester is selected from aliphatic and aromatic polyesters such as poly(butylene adipate-co-terephthalate) (PBAT), poly(butylene succinate-co-adipate) (PBSA), PLA, PLGA, PGA, esterified starch (e.g. starch acetate), including any copolymer or any mixture thereof. In some embodiments, the thermoplastic starch comprises a starch (i.e. modified or unmodified plant starch, such as corn starch, cellulose ester, alkylated cellulose, etc.) and a plasticizer (e.g. a material which is miscible with the cellulose fat, oil, a gum, a phospholipid, a fatty acid, a fatty alcohol, a polyol, a lipid, a fatty acid monoglyceride, a fatty acid diglyceride, a fatty acid triglyceride, alkylated citrate, a monosaccharide, a disaccharide, an oligosaccharide or any combination thereof). In some embodiments, the biodegradable polymer is a polyester and/or thermoplastic starch.

Exemplary polyester includes Novamont's Origo-Bi polymer (i.e. PBAT).

In some embodiments, at least 50%, at least 80%, at least 85%, at least 90%, at least 93%, at least 95%, at least 97%, at least 99%, at least 99.9% including any range between, by total dry weight of the biodegradable polymer is bioerodible. In some embodiments, at least 50%, at least 80%, at least 85%, at least 90%, at least 93%, at least 95%, at least 97%, at least 99%, at least 99.9% including any range between, by total dry weight of the biodegradable polymer is biodegradable. In some embodiments, at least 50%, at least 80%, at least 85%, at least 90%, at least 93%, at least 95%, at least 97%, at least 99%, at least 99.9% including any range between, by total dry weight of the biodegradable polymer is compostable.

In some embodiments, the biodegradable polymer is substantially characterized by any one of compostability, biodegradability, and/or bioerosion under ambient conditions (e.g., a temperature between-10 and 50° C., between 1° and 30° C., or between 5 and 40° C., presence of microorganisms under aerobic and/or anaerobic conditions) within a time ranging between 1 week and 2 years, including any range between; wherein substantially refers to at least 50%, at least 80%, at least 85%, at least 90%, at least 93%, at least 95%, at least 97%, at least 99%, at least 99.9% including any range between, by total dry weight of the biodegradable polymer. In some embodiments, the biodegradable polymer is compostable. In some embodiments, the biodegradable polymer is compostable within a time period between 5 weeks and 30 weeks, between 10 and 40 weeks, between 10 and 30 weeks, including any range between.

In some embodiments, the biodegradable polymer is in a form of a polymeric matrix comprising an interpenetrating network of polymeric chains, and wherein the additional constituents of the composition (e.g. organic waste component and/or additives such as gliding agent) are enclosed or homogenously distributed within the polymeric matrix.

In some embodiments, the composition comprises the polymeric matrix in contact with the organic waste component. In some embodiments, the composition comprises the polymeric matrix in contact with a plurality of organic waste components. In some embodiments, the organic waste component is bound to the polymeric matrix. In some embodiments, the organic waste component is incorporated within the polymeric matrix. In some embodiments, the organic waste component is embedded into the polymeric matrix. In some embodiments, the organic waste component is adhered to the polymeric matrix. In some embodiments, the organic waste component is adsorbed onto the polymeric matrix.

In some embodiments, the polymeric matrix provides an adhesive for a plurality of particles of the organic waste component and/or for the additive. In some embodiments, the polymeric matrix reinforces the composition. In some embodiments, the plurality of particles of the organic waste component are held together by the polymeric matrix. In some embodiments, the components (e.g. the organic waste component) of the composition of the invention are homogenously distributed within the polymeric matrix. In some embodiments, the polymeric matrix provides a plasticity to the composition sufficient for shaping thereof such as by injection molding. In some embodiments, the polymeric matrix further comprises a plasticizer.

In some embodiments, the amount of the biodegradable polymer within the composition is sufficient for inducing flowability and/or processability of the composition by means of thermoplastic polymer processing; and for providing mechanical stability to the composition or to the article derived (or processed) therefrom.

In some embodiments, the components of the composition (e.g. the biodegradable polymer, at least one organic waste component, and optionally at least one gliding agent) are uniformly mixed. In some embodiments, the composition of the invention is in a form of a composite material or of a solid composite. In some embodiments, the entire composition or composite is substantially homogenous.

As used herein, “composite material” is a material produced from two or more constituent materials with notably dissimilar chemical or physical properties that, when merged, create a material with properties, unlike the individual elements.

In some embodiments, the homogenous composite is referred to a material which cannot be easily separated into individual constituents (e.g., the biodegradable polymer, the organic waste material, and the gliding agent of the invention).

In some embodiments, the composition of the invention consists essentially of the biodegradable polymer, the organic waste material, and the gliding agent of the invention, wherein the weight portion of the constituents within the composition is as described herein). In some embodiments, at least 80%, at least 90%, at least 95%, at least 97%, or between 80 and 99%, between 80 and 95%, between 90 and 95%, between 95 and 99%, between 90 and 97% of the composition and/or article of the invention consists of the biodegradable polymer, the organic waste material, and the gliding agent of the invention. In some embodiments, at least 80%, at least 90%, at least 95%, at least 97%, or between 80 and 99%, between 80 and 95%, between 90 and 95%, between 95 and 99%, between 90 and 97% of the composition and/or article of the invention consists of the biodegradable polymer (i.e. a polyester such as PBAT and/or thermoplastic starch), the organic waste material (i.e. wood residual material, compost or both), and the gliding agent of the invention (i.e. clay mineral, such as talc). In some embodiments, the composition of the invention is devoid of a plasticizer, which is not the gliding agent, or the thermoplastic polymer disclosed herein.

The term “consisting essentially of” means that the composition, method, or structure may include additional ingredients, steps and/or parts, but only if the additional ingredients, steps and/or parts do not materially alter the basic and novel characteristics of the claimed composition, method, or structure. Thus, the term “consisting essentially of” means that in addition to the disclosed constituents, the composition or article may further include additive(s) such as colorant, stabilizer, preservative, taste masking agent, flavoring agent, etc. In some embodiments, the terms “substantially” and the term “consisting essentially of” are used herein interchangeably.

In some embodiments, the composition of the invention comprises at least one organic waste component. In some embodiments, the composition of the invention comprises two or more types of organic waste components. In some embodiments, the organic waste component is or comprises waste particulate material. In some embodiments, the terms “organic waste component” and “waste particulate material” are used herein interchangeably.

In some embodiments, a w/w ratio of the organic waste component to the biodegradable polymer within the composition ranges between 1:1 to 10:1, between 1:1 to 3:1, between 3:1 to 4:1, between 4:1 to 5:1, between 5:1 to 6:1, between 6:1 to 7:1, between 7:1 to 8:1, between 8:1 to 10:1, between 2:1 to 10:1, between 2:1 to 3:1, between 2:1 to 7:1, between 2:1 to 5:1, including any range therebetween.

In some embodiments, a w/w concentration of the organic waste component within the composition of the invention is between 50 and 90%, between 60 and 90%, between 60 and 85%, between 70 and 90%, between 65 and 90%, between 70 and 80%, between 65 and 80%, including any range therebetween.

In some embodiments, the organic waste component comprises plant material or parts of plant material. In some embodiments, the organic waste component is organic residual material. In some embodiments, the organic waste component comprises cellulosic material. In some embodiments, the organic waste component comprises between 50 and 99%, between 60 and 99%, between 60 and 85%, between 70 and 99%, between 65 and 99%, between 70 and 80%, between 65 and 80%, between 80 and 99%, between 90 and 99%, between 95 and 99% of a cellulosic material, or of a plant material by dry weight of the organic waste component, including any range therebetween.

In some embodiments, the organic waste component comprises wood residues. Various wood residues are well-known in the art. In some embodiments, the organic waste component is characterized by a greater degradation time in soil, as compared to the degradation time of the biopolymer of the invention.

In some embodiments, the organic waste component comprises a processed plant material. In some embodiments, the processed plant material is or comprises composted plant material, also referred to herein as “compost”. The term “composted plant material” encompasses any cellulosic or any plant material which has undergo at least partial composting (i.e. physical and/or chemical disintegration of the plant material upon exposing thereof to enzymatic degradation or microbial degradation). Composted plant material or compost may be obtained by various method such as aerobic or anerobic composting, industrial or home composting, etc. The term “compost” encompasses disintegrated plant material, while retaining its particulate matter state, so that the compost is characterized by average particle size ranging between about 1 and about 4 mm, between 1.5 and about 4 mm, between 1.7 and about 4 mm, between 1.3 and about 4 mm, between 1.8 and about 4 mm, between about 2 and about 4 mm, between about 1 and about 2 mm, between about 2 and about 3 mm, between about 3 and about 4 mm, including any range therebetween.

In some embodiments, the organic waste component comprises or consist essentially of compost. In some embodiments, compost constitutes between 50 and 99%, between 60 and 99%, between 60 and 85%, between 70 and 99%, between 65 and 99%, between 70 and 80%, between 65 and 80%, between 80 and 99%, between 90 and 99%, between 95 and 99% by dry weight of the organic waste component.

In some embodiments, the organic waste component comprises one or more particles characterized by slow degradation (such as wood chips, ash, bark, etc.) and one or more particles characterized by fast degradation (such as compost). In some embodiments, a w/w ratio between particles characterized by a slow degradation and particles characterized by fast degradation is between 3:1 and 1:1, between 3:1 and 2:1, between 2:1 and 1:1, including any range therebetween.

In some embodiments, the organic waste component comprises a material having a high cellulose content. In some embodiments, the cellulose content, as used herein, is related to cellulose, hemicellulose and lignin or any combination thereof.

In some embodiments, the organic waste component has a cellulose content of at least 40%, at least 50%, at least 60%, at least 70%, at least 75%, at least 80%, at least 85%, at least 90%, at least 92%, at least 95%, at least 97%, at least 99%, including any range between.

In some embodiments, the organic waste component is or comprises a plant material selected from any one of: wood chips, sawdust, digestate, biomass, maize residual, cereals residual, soil, dirt, lop, grass clippings, leaves, hay, straw, shredded bark, whole bark nuggets, shells, shredded paper, cardboard, wool, peat, hemp biomass, coffee residues, wood ash or other organic material ash, or any combination thereof. In some embodiments, the organic waste component is or comprises a plant material as disclosed herein, wherein the plant material is a composted plant material.

In some embodiments, the organic waste component and/or the composition of the invention is substantially devoid of lignin.

In one embodiment, the organic waste component comprises soil.

In some embodiments, the organic waste component comprises particles having an average particle size between 1 and 4 mm, between 2 and 4 mm, between 1 and 2 mm, between 2 and 3 mm, between 3 and 4 mm, including any range therebetween.

In some embodiments, the organic waste component comprises particles having an average particle size of less than 3 mm, less than 2.8 mm, less than 2.5 mm, less than 2.3 mm, less than 2.1 mm, less than 2 mm, less than 1.8 mm, less than 1.5 mm, less than 1.3 mm, less than 1.1 mm, or between 1 and 2, between 1.5 and 2, including any range therebetween.

In one embodiment of the invention, the organic waste component comprises particles with a particle size about 2 mm or about 1 mm. In one embodiment of the invention, the organic waste component comprises particles that are equal to or smaller than 2.8 mm. In one embodiment of the invention, the organic waste component comprises particles that are equal to or smaller than 2.5 mm. In one embodiment of the invention, the organic waste component comprises particles that are equal to or smaller than 2.2 mm. In one embodiment of the invention, the organic waste component comprises particles that are equal to or smaller than 2 mm. In one embodiment of the invention, more than 80% of the organic waste component particles are characterized by a particle size of about 2 mm or about 1 mm (i.e. ±10%). In one embodiment of the invention, more than 85% of the organic waste component particles are characterized by a particle size of about 2 mm or about 1 mm (i.e. ±10%). In one embodiment of the invention, more than 90% of the organic waste component particles are characterized by a particle size of about 2 mm or about 1 mm (i.e. ±10%). In one embodiment of the invention, more than 95% of the organic waste component particles are characterized by a particle size of about 2 mm or about 1 mm (i.e. ±10%).

In one embodiment of the invention, at least 90%, at least 92%, at least 95%, at least 97%, at least 99%, of the organic waste component comprises any of wood chips, compost, or both.

In another embodiment, the composition as described herein comprises both sawdust and compost. In another embodiment, the weight (w:w) ratio between sawdust and compost is 4:1 to 1:2. In another embodiment, the weight (w:w) ratio between sawdust and compost is 3:1 to 1:1. In another embodiment, the weight (w:w) ratio between sawdust and compost is 2:1 to 1:1. In another embodiment, the weight (w:w) ratio between sawdust and compost is 2:1±30%. In another embodiment, the weight (w:w) ratio between sawdust and compost is 2:1±20%. In another embodiment, the weight (w:w) ratio between sawdust and compost is 2:1±10%. In another embodiment, the weight (w:w) ratio between sawdust and compost is 1:1±30%. In another embodiment, the weight (w:w) ratio between sawdust and compost is 1:1±20%. In another embodiment, the weight (w:w) ratio between sawdust and compost is 1:1±10%.

In another embodiment, the composition as described herein comprises both soil and compost. In another embodiment, the weight (w:w) ratio between soil and compost ranges from 4:1 to 1:2. In another embodiment, the weight (w:w) ratio between soil and compost is 3:1 to 1:1. In another embodiment, the weight (w:w) ratio between soil and compost ranges from 2:1 to 1:1. In another embodiment, the weight (w:w) ratio between soil and compost is 2:1±30%. In another embodiment, the weight (w:w) ratio between soil and compost is 2:1±20%. In another embodiment, the weight (w:w) ratio between soil and compost is 2:1±10%. In another embodiment, the weight (w:w) ratio between soil and compost is 1:1±30%. In another embodiment, the weight (w:w) ratio between soil and compost is 1:1±20%. In another embodiment, the weight (w:w) ratio between soil and compost is 1:1±10%. In another embodiment, the weight (w:w) ratio between soil and compost is 1:2±30%. In another embodiment, the weight (w:w) ratio between soil and compost is 1:2±20%. In another embodiment, the weight (w:w) ratio between soil and compost is 1:2±10%.

In one specific embodiment, the organic waste component is a mixture of any two or more components selected from: wood chips, soil, ash, compost, biomass, and saw dust. In some embodiments, the organic waste component is a mixture of wood chips and/or saw dust and compost. The inventors successfully utilized a mixture of (i) compost and (ii) wood chips and/or saw dust for the fabrication of exemplary articles or compositions of the invention.

In some embodiments, compost is any composted organic material known to one of average skill in the art. Composting maybe performed under aerobic or anerobic conditions. In some embodiments, compost refers to any aerobically or anaerobically degraded organic material. In some embodiments, compost refers to composted organic waste material. In some embodiments, compost is the result of Grub composting. In another embodiment, compost is Bokashi compost. In another embodiment, a compost comprises EM1 (lactic acid bacteria, yeast and phototrophic (PNSB) bacteria). In one preferred embodiment, the organic waste component comprises compost and wood chips, and optionally saw dust. In one preferred embodiment, the organic waste component comprises compost, wood chips and up to 10% w/w of a biopolymer (e.g. lignin), wherein the ratio of wood chips to compost is as described herein.

In some embodiments, the compost is characterized by low residual metal content (such as inorganic metal salts or metal/metalloid oxides, wherein exemplary metal/metalloids are selected from Fe, Na, Li, K, Ca, Mg, Mn, Zn, Cd, Pb, Cu, Ni, Cr and Si). In some embodiments, the low residual metal content refers to a w/w concentration of inorganic metal salts or metal/metalloid oxides within the compost of between 1 ppm and 0.1%, between 1 and 500 ppm, between 1 and 700 ppm, between 1 and 800 ppm, between 1 and 300 ppm, between 1 and 100 ppm, between 1 and 50 ppm, between 1 and 30 ppm, between 1 and 20 ppm, between 1 and 10 ppm, including any range between.

In some embodiments, a w/w ratio of wood chips to compost is between 4:1 and 1:1, between 4:1 and 3:1, between 3:1 and 2:1, between 2:1 and 1:1, including any value or range therebetween. In some embodiments, the ratio between wood chips and compost predetermines the degradation time (in the soil) of the composition and/or article of the invention.

In another embodiment, compost is a compost tea. In another embodiment, compost is Hügelkultur. In another embodiment, compost comprises Humanure. In another embodiment, compost is Vermicompost.

According to some embodiments of the invention the organic waste component includes material having different sized particles. The particles may be between 0.125 mm and 2 mm in size, or greater than 2 mm.

In some embodiments, the particle size of the organic waste component is about 2 mm. Without being bound to any particular theory, particles having a size of more than 2.5 mm did not result in a compressible composition suitable for manufacturing an article of the invention.

In some embodiments, the soil is rich in clay. Clay is the most active mineral component of soil. It is a colloidal and crystalline material. In soils, clay is defined in a physical sense as any mineral particle less than two microns in effective diameter. Clay is now known to be a precipitate with a mineralogical composition different from its parent materials and is classed as a secondary mineral. The type of clay that is formed is a function of the parent material and the composition of the minerals in solution. The clays of soil are a mixture of the various types of clay (crystalline, amorphous or sesquioxide).

In some embodiments, the gliding agent comprises a clay mineral (e.g. a metal silicate, such as talc), a wax (natural or synthetic wax), a protein (e.g. a plant protein), glycerol, a glycol (e.g. ethylene glycol, propylene glycol, PEG), a fatty acid including any ester or an amide thereof (such as mono-, di or triglyceride), or any combination thereof.

In some embodiments, the composition comprises or consists essentially of between 50 and 90% of the waste particulate material (e.g. wood saw, and/or compost) having an average particle size of between about 1 and 2 mm; between about 15 and 30% w/w of the biodegradable polymer; between 1 and 5% w/w of the gliding agent; wherein the biodegradable polymer is or comprises a polyester (e.g. PBAT), and/or a thermoplastic starch (e.g. Matter-Bi); and the gliding agent is or comprises talc.

One of ordinary skills in the art will appreciate, that the exact ratios between the components of the composition or article of the invention may vary and is predetermined by the desired degradation time of the of the composition or article.

In some embodiments, the composition of the invention comprises a water absorbing agent, or a disintegrant. In some embodiments, the water absorbing agent comprises any of mono- or a di-saccharide, starch, croscarmellose, crospovidone, and starch glycolate including any salt or any combination thereof. Additional water absorbing agents, or a disintegrants are well-known in the art.

In some embodiments, the composition of the invention comprises between 0.1 and 10%, between 0.5 and 5%, between 0.1 and 5%, between 0.1 and 1%, between 1 and 5%, between 2 and 5%, between 5 and 10% by weight of the composition, including any range between.

In some embodiments, the water absorbing agent is in a form of solid particles with an average particle size between 10 um and 2 mm, between 10 um and 1 mm, between 100 um and 2 mm, between 100 um and 1 mm, including any range between.

In some embodiments, the water absorbing agent is or comprises a biopolymer. In some embodiments, the water absorbing agent comprises at least one biopolymer. In some embodiments, the water absorbing agent comprises two or more types of biopolymers. In some embodiments, the composition of the invention comprises at least one biopolymer and further comprises at least one emulsifying agent.

In some embodiments, the w/w concentration of the biopolymer within the composition of the invention is at most 40%, at most 35%, at most 30%, at most 25%, at most 20%, at most 15%, at most 10%, at most 8%, at most 5%, including any range therebetween.

In some embodiments, the w/w concentration of the biopolymer within the composition of the invention is between 10 and 45%, between 10 and 20%, between 20 and 40%, between 20 and 30%, between 30 and 40%, including any range therebetween. In some embodiments, the w/w concentration of the biopolymer within the composition of the invention is between 30 and 20%.

In some embodiments, the biopolymer is a mono- or a disaccharide, a polysaccharide, or a polyamino acid (e.g. a peptide, or a protein). In some embodiments, the biopolymer is a natural or a synthetic polymer. In some embodiments, the biopolymer is derived (e.g. via chemical and/or biochemical modification, such as alkylation, phosphorylation, glycosylation, acetylation, etc.) from a natural polymer.

In some embodiments, the biopolymer is selected from the group consisting of flour, lignin, starch, modified starch, cellulose, carboxymethylcellulose, carboxyethyl cellulose, methylcellulose, ethylcellulose, nitrocellulose, chitosan, alginate, pectin, Xanthan gum, gelatin, or any combination thereof.

In some embodiments, the biopolymer is a polysaccharide. In some embodiments, the polysaccharide is selected from flour, lignin, starch, modified starch, cellulose, carboxymethylcellulose, carboxy ethylcellulose, methylcellulose, ethylcellulose, nitrocellulose, chitosan, alginate, pectin, Xanthan gum, or any combination thereof.

In some embodiments, the biopolymer is sugar. In some embodiments, the biopolymer increases the degradability of the composition or article. In some embodiments, the biopolymer reduces degradation period (e.g. upon planting in soil) of the composition or of the article of the invention.

In some embodiments, the one or more biopolymers of the invention is substantially biodegradable and/or bioerodible. In some embodiments, at least 80%, at least 85%, at least 90%, at least 93%, at least 95%, at least 97%, at least 99% by total dry weight of the biopolymer is biodegradable.

It is to be understood that the term “flour” may include any one of wheat flour, flour from grains, such as those chosen from buckwheat flour, semolina flour, corn flour, corn starch, corn sledge, rice flour, tapioca flour, potato flour, soy flour, ground flax meal, flax flour, hemp flour, and any mixtures thereof.

In some embodiments, the composition of the invention further comprises an additive selected from a dye, a pigment, a scent, a pesticide, a growth hormone, a fertilizer, mucilage, a preservative, sorbic acid or a salt thereof or any combination thereof.

In some embodiments, the w/w concentration of the additive within the composition of the invention is between 0.5 and 10%, between 0.1 and 0.5%, between 0.5 and 1%, between 1 and 2%, between 2 and 2.5%, between 2.5 and 3%, between 3 and 4%, between 4 and 5%, between 5 and 6%, between 6 and 7%, between 7 and 10%, including any range between.

In some embodiments, the pesticide comprises mold, fungus, and/or yeast inhibitor. In one embodiment, the fungicide is potassium sorbate. In one embodiment, the fungicide is calcium sorbate. In one embodiment, the fungicide is sorbic acid. In one embodiment, the fungicide is Natamycin. In one embodiment, the fungicide is calcium Acetate. In one embodiment, the fungicide is sodium propionate. In one embodiment, the fungicide is potassium propionate. In one embodiment, the fungicide is calcium propionate. In one embodiment, the fungicide is propionic acid. In one embodiment, the fungicide is sodium diacetate.

In another embodiment, the w/w concentration of the fungicide within the composition is between 0.01 and 5%, between 0.01 and 0.1%, between 0.1 and 0.5%, between 0.5 and 1%, between 1 and 2%, between 2 and 5%, including any range between.

In some embodiments, the composition of the invention further comprises mucilage. In one embodiment, mucilage is a thick mixture of polar glycoprotein and an exopolysaccharide produced by a plant or a microorganism.

In some embodiments, mucilage is derived from Aloe vera. In another embodiment, mucilage is derived from Basella alba (Malabar spinach). In another embodiment, mucilage is derived from cactus. In another embodiment, mucilage is derived from Chondrus crispus (Irish moss). In another embodiment, mucilage is derived from Dioscorea opposita (nagaimo, Chinese yam). In another embodiment, mucilage is derived from Drosera (sundews). In another embodiment, mucilage is derived from Drosophyllum lusitanicum. In another embodiment, mucilage is derived from fenugreek. In another embodiment, mucilage is derived from flax seeds. In another embodiment, mucilage is derived from kelp. In another embodiment, mucilage is derived from liquorice root. In another embodiment, mucilage is derived from marshmallow. In another embodiment, mucilage is derived from mallow. In another embodiment, mucilage is derived from mullein. In another embodiment, mucilage is derived from okra. In another embodiment, mucilage is derived from parthenium. In another embodiment, mucilage is derived from pinguicula (butterwort). In another embodiment, mucilage is derived from Psyllium seed husks. In another embodiment, mucilage is derived from salvia hispanica (chia) seed. In another embodiment, mucilage is derived from Ulmus rubra bark (slippery elm).

In one embodiment, mucilage is Trigonella foenum-graecum mucilage. In another embodiment, the w/w concentration of the mucilage within the composition is between 0.01 and 5%, between 0.01 and 0.1%, between 0.1 and 0.5%, between 0.5 and 1%, between 1 and 2%, between 2 and 5%, including any range between.

In some embodiments, the composition of the invention has an average material density between 0.4 and 1 g/mL, between 0.4 and 0.6 g/mL, between 0.6 and 0.7 g/mL, between 0.7 and 0.8 g/mL, between 0.8 and 0.9 g/mL, between 0.9 and 1 g/mL, between 1 and 1.2 g/mL, including any range therebetween. In some embodiments, the composition has an average material density of 0.8 (±0.4) g/mL.

In some embodiments, the composition of the invention is shapeable, i.e., flowable, deformable and/or processable. In some embodiments, the composition of the invention is pliable. In some embodiments, the composition of the invention is moldable. In some embodiments, the composition of the invention is shapeable by injection molding. In some embodiments, the composition of the invention is suitable for injection molding. In some embodiments, the composition of the invention is compatible with the injection molding processing.

In some embodiments, the composition of the invention is shapeable or flowable under suitable conditions comprising a temperature above the glass transition point of the biodegradable polymer, and pressure between 100 and 5000 bar, between 300 and 5000 bar, between 500 and 5000 bar, between 500 and 3000 bar, between 700 and 5000 bar, between 700 and 3000 bar, between 800 and 5000 bar, between 800 and 3000 bar, between 800 and 2000 bar, including any range between. In some embodiments, the composition of the invention shapeable or flowable under suitable conditions comprising a pressure as described herein and a temperature between 10° and 250° C., between 12° and 250° C., between 14° and 250° C., between 10° and 220° C., between 14° and 220° C., between 14° and 180° C., between 12° and 180° C., between 14° and 170° C., between 15° and 180° C., including any range between.

In some embodiments, the composition of the invention is in a form of a solid mixture (or powderous composition). In some embodiments, the solid mixture is a particulate matter characterized by an average particle size between 1 and 4 mm, between 2 and 4 mm, between 1 and 2 mm, between 2 and 3 mm, between 3 and 4 mm, or less than 3 mm, less than 2.8 mm, less than 2.5 mm, less than 2.3 mm, less than 2.1 mm, less than 2 mm, less than 1.8 mm, less than 1.5 mm, less than 1.3 mm, less than 1.1 mm, or between 1 and 2, between 1.5 and 2, including any range therebetween. In some embodiments, the mixture is substantially homogenous (e.g. the concertation of each of the mixture constituents varies within the entire mixture by not more than 20%, not more than 15%, not more than 10%, by not more than 5%, or between 1 and 20%, between 1 and 15%, between 1 and 10%, including any range between). Homogeneity of the mixture, as disclosed herein, can be determined according to well-known methods, for example, by taking at least 3 samples from the entire composition, determining the relative w/w concentration of one or more of the mixture constituents in each sample, and further calculating the standard deviation of the concentration of one or more of the mixture constituent(s). As disclosed above, the standard deviation in a homogenous mixture measured as disclosed above, should not exceed 20%.

In some embodiments, the composition of the invention is in a form of a composite. The term “composite” generally refers to a mixture which cannot be separated into individual constituents solely by sorting, without applying heat or using dissolution and/or extraction technique. Additionally, as opposed to a mixture (e.g. powderous composition disclosed above) the “composite” cannot be separated into individual constituents without destroying the physical appearance, homogeneity and/or functional properties thereof. In some embodiments, the functional properties of the composite as used herein can be determined based on the amount of pressure required for heat processing of the composite (e.g. by injection molding or by extrusion). A skilled artisan will appreciate that a homogenous composite requires application of lower pressure, as compared to a mixture.

In some embodiments, the composite is in a form of particles (e.g. granules). In some embodiments, the particles of the invention are characterized by a particle size ranging between 0.01 and 10 mm, between 0.01 and 0.1 mm, between 0.1 and 0.2 mm, between 0.1 and 5 mm, between 0.1 and 0.5 mm, between 0.5 and 1 mm, between 1 and 2 mm, between 2 and 3 mm, between 3 and 5 mm, between 5 and 7 mm, between 7 and 10 mm, including any range or value between.

In some embodiments, the composite is an extrudate. In some embodiments, the extrudate has a predefined shape and/or dimension.

In some embodiments, the term “particle size” refers to an average particle size. In some embodiments, the term “particle size” refers to an average value of at least one dimension (e.g. radius or cross-section for a spherical particle, or length and/or width dimension for a cylindrical particle) of the particles within the composition. In some embodiments, the term “particle size” refers to an average cross-section value of the particles within the composition (e.g. for non-uniformly shaped particles, or for particles being devoid of a defined shape). In some embodiments, the term “particle size” refers to a number average particle size. One of ordinary skills in the art will appreciate that the average particle size (e.g. number average particle size) can be measured according to well-known methods.

In some embodiments, the plurality of particles within the composition have a spherical shape, elliptical shape, and/or a cylindrical shape. In some embodiments, the particles have a substantially uniform shape, or the particles are substantially non-uniform. In some embodiments, the particles have a random shape.

In some embodiments, the particles have a substantially cylindrical shape, wherein an average length dimension of the particles is between 0.1 and 20 mm, between 0.1 and 0.2 mm, between 0.2 and 0.5 mm, between 0.5 and 1 mm, between 1 and 2 mm, between 1 and 20 mm, between 1 and 10 mm, between 1 and 15 mm, between 2 and 3 mm, between 3 and 5 mm, including any range therebetween. In some embodiments, the average width (or cross-section) dimension of the particles is between 0.1 and 10 mm, between 0.5 and 10 mm, between 1 and 10 mm, between 0.5 and 5 mm, between 1 and 5 mm, between 2 and 10 mm, between 2 and 5 mm, including any range between.

In some embodiments, the composition is in a form of a kit comprising particles, as described herein wherein the particles comprise the biodegradable polymer and the gliding agent. In some embodiments, the kit further comprises the waste particulate material. In some embodiments, a w/w ratio between the biodegradable polymer and the gliding agent within the particle is between 10:1 and 5:1 including any range therebetween.

In some embodiments, the kit comprises instruction for mixing the particle with the waste particulate material to obtain the composition of the invention. In some embodiments, the kit comprises instruction for mixing the particle with the waste particulate material prior to feeding the resulting composition into the processing equipment (e.g. injection molding machine). In some embodiments, the kit comprises instruction for mixing the particle with the waste particulate material at a w/w ratio between the waste particulate material and the particles ranging between 10:1 and 2:1 including any range therebetween.

### Article

The invention is particularly useful for articles or containers for use inter alia as food ware, or for use in agriculture and home gardening, such as plant pots, plug trays, and any containers or receptacles of similar use. In one aspect, there is provided an article comprising at least one wall comprising the organic waste component (e.g., a waste particulate material, such as compost) and the biodegradable polymer; and optionally the gliding agent; wherein a weight portion of the biodegradable polymer within the composition is between 10 and 50%. In some embodiments, the constituents of the article of the invention and/or ratios between the constituents within the article are as described hereinabove for the composition of the invention. In some embodiments, the wall of the article is a solid. In some embodiments, the wall of the article has a predestined geometrical shape and/or dimension.

In some embodiments, the wall of the article consist essentially of a uniform or homogeneous material. In some embodiments, the wall of the article is in a form of a composite, as disclosed herein. In some embodiments, the wall of the article is characterized by sufficient mechanical strength (or stability) to support growth of a plant (e.g. when the article is a plant container), and/or to contain a solid or liquid food matter (e.g. when the article is a dish). In some embodiments, the article is in a form of a container. In some embodiments, the wall of the container is water impermeable. In some embodiments, the wall of the container is gas permeable (e.g. air, water vapor).

In another aspect of the invention, there is provided an article comprising the composition of the invention. In some embodiments, the article is a container. In some embodiments, the article is a food ware, or a planting article. In some embodiments, the article is a planting container.

In some embodiments, the article of the invention is stable (e.g. substantially retains its shape, geometrical form and is substantially devoid of structural defects or cracks, disintegration) when exposed to greenhouse conditions and/or to irrigation, for a time period of at least 10 months, at least 6 months, at least 5 months, at least 4 months, at least 3 months, at least 2 months, at least 1 month, at least 3 weeks including any range between.

In some embodiments, the article of the invention is stable when exposed to greenhouse conditions for a period ranging between 2 weeks and 10 months (m), between 2 w and 10 m, between 2 w and 6 w, between 6 w and 2 m, between 2 m and 5 m, between 5 m and 7 m, between 7 m and 10 m, including any range between. The exact stability period is predetermined by the specific greenhouse cultivation time required for the plant.

In some embodiments, the term “stable” refers to the capability of the article to retain at least 80%, at least 90%, at least 95%, at least 99% of the geometrical shape and/or mechanical properties thereof under greenhouse conditions. In some embodiments, the term “stable” refers to the capability of the article to retain at least 80%, at least 90%, at least 95%, at least 99% of the geometrical shape and/or mechanical properties thereof under regular storage conditions for a period ranging between 1 and 24 months (m), between 1 and 10 m, between 2 m and 24 m, between 5 m and 36 m, including any range between.

In some embodiments, the stable article of the invention is substantially devoid of openings, cracks, or other structural defects upon exposure to greenhouse conditions for a time period described hereinabove. In some embodiments, the article is stable when it substantially retains its mechanical stability, so as to be suitable for subsequent planting in the open field, e.g. via an automated planting process.

In some embodiments, at least 70%, at least 80%, at least 85%, at least 90%, at least 95%, at least 97%, at least 99% of the articles of the invention (or of the entire volume of the article) including any range between, are devoid of structural defects (e.g. cracks) upon exposure thereof to greenhouse condition for a time period ranging between 2 weeks and 10 months (m), between 2 w and 10 m, between 2 w and 6 w, between 6 w and 2 m, between 2 m and 5 m, between 5 m and 7 m, between 7 m and 10 m, under including any range between.

As used herein, the term “irrigation” refers to any known irrigation technique, such as drip irrigation, sprinkler irrigation, drip irrigation, surface irrigation, subsurface irrigation, or any combination thereof.

In some embodiments, the stable article of the invention refers to an article configured to substantially retain its function as a container e.g. under normal storage condition and/or under greenhouse conditions, for a time period as described herein. In some embodiments, the stable article of the invention, such as a plant container is configured to provide any of: (i) enclosing at least 90%, at least 93%, at least 95%, at least 97%, at least 99%, at least 99.9% of the plant roots, including any range between; (ii) providing an efficient barrier between the plant root and the ambient (e.g. ambient atmosphere) sufficient for preventing damage to the plant root, wherein damage refers to a mechanical damage (e.g. during transplantation) and/or to a damage induced by a pest. In some embodiments, the article is stable when it substantially (e.g. at least 60%, at least 70%, at least 80%, at least 90%, including any range between) retains its mechanical stability as determined by Punch test. In some embodiments, the stability of the article refers to the ability of the article to retain at least 60%, at least 70%, at least 80%, at least 90%, including any range between of its initial mechanical strength.

In some embodiments, the article of the invention retains at least 60%, at least 60%, at least 70%, at least 80% of its initial mechanical strength (e.g. as determined by compressive strength analysis) under soil composting conditions for a time period of at least 1 week, at least 2 weeks, at least 5 weeks, at least 6 weeks, at least 10 weeks, at least 12 weeks, including any value or range between. In some embodiments, the article of the invention is stable under soil composting conditions for a time period ranging between 1 and 20 weeks, between 2 and 20 weeks, between 2 and 15 weeks, between 1 and 12 weeks, between 2 and 12 weeks, between 2 and 10 weeks, between 1 and 5 weeks, including any value or range between.

In some embodiments, the article is biocompatible or bioerodible. In some embodiments, the article is at least partially degradable or biodegradable. In some embodiments, the article is at least partially erodible or bioerodible.

In some embodiments, the mechanical properties (e.g. strength and/or elasticity) of the article are reduced upon contact with soil. Without being bound to any theory it is postulated that biodegradation is induced by degradation of the organic matter such as the biopolymer (e.g. flour) and the organic waste component (e.g. wood and/or compost). After degradation of the organic matter, the article loses its structural intactness (e.g. shape or geometric form), thus resulting in a substantial degradation of the article. Without being bound to any theory it is postulated that an article being devoid of the biopolymer (e.g. flour) has a reduced biodegradability. In some embodiments, the article being devoid of the biopolymer (e.g. flour).

In some embodiments, the article of the invention characterized by any one of compostability, biodegradability, and/or bioerosion under ambient conditions (e.g., a temperature between-10 and 50° C., between 10 and 30° C., or between 5 and 40° C. presence of microorganisms, normal atmospheric pressure, under aqueous or dry conditions, and under aerobic and/or anaerobic conditions) within a time ranging between 1 and 40 weeks, between 5 and 20 weeks, between 5 and 40 weeks, between 5 and 18 weeks, between 7 and 20 weeks, between 7 and 15 weeks, between 10 and 20 weeks, between 12 and 20 weeks, between 10 and 40 weeks, between 15 and 40 weeks, between 18 and 30 weeks, between 15 and 30 weeks, between 15 and 20 weeks, between 5 and 20 weeks, between 8 and 20 weeks, between 8 and 15 weeks, including any range between. In some embodiments, the article of the invention is soil compostable within a time period ranging between 1 and 40 weeks, between 5 and 20 weeks, between 5 and 40 weeks, between 5 and 18 weeks, between 7 and 20 weeks, between 7 and 15 weeks, between 10 and 20 weeks, between 12 and 20 weeks, between 10 and 40 weeks, between 15 and 40 weeks, between 18 and 30 weeks, between 15 and 30 weeks, between 15 and 20 weeks, between 5 and 20 weeks, between 8 and 20 weeks, between 8 and 15 weeks, including any range between. In some embodiments, the article of the invention undergoes disintegration (so that the article losses its shape/functional properties, such as mechanical strength) under soil composting conditions within a time period ranging between 1 and 40 weeks, between 5 and 20 weeks, between 5 and 40 weeks, between 5 and 18 weeks, between 7 and 20 weeks, between 7 and 15 weeks, between 10 and 20 weeks, between 12 and 20 weeks, between 10 and 40 weeks, between 15 and 40 weeks, between 18 and 30 weeks, between 15 and 30 weeks, between 15 and 20 weeks, between 5 and 20 weeks, between 8 and 20 weeks, between 8 and 15 weeks, including any range between.

In some embodiments, the soil compostable article undergoes chemical or physical decomposition (also used herein as “disintegration”), wherein disintegration refers to (i) complete disintegration (so that no compressive strength can be measured), or to (ii) partial disintegration, such as the article has not more than 20%, not more than 10% of the initial mechanical strength (e.g. as determined by compressive strength analysis).

The term “compostable” encompasses industrially compostable, home compostable, soil compostable or any combination thereof. The term “compostable” refers to the ability of a material to disintegrate upon exposing thereof to enzymatic degradation or microbial degradation (e.g. bacterial and/or fungal degradation, or degradation by other microorganisms).

As used herein, the term “disintegration” including any grammatical form thereof includes the tendency of a material to chemically decompose, or to physically decompose into smaller fragments under composting conditions (e.g. open air composting, anerobic composting, soil composting, etc.). Chemical decomposition is an intrinsic property of the material itself, and the material can exhibit different degrees of chemical decomposition, depending on the specific conditions to which it is exposed. Physical decomposition depends both on the material itself, as well as the physical size and configuration of the article being tested.

Compostability of the article can be measured according to well-known tests, for example soil compostability can be determined according to ISO 17556 (2012).

In some embodiments, the article of the invention is characterized by any one of: 1) biodegradability such that at least 90% carbon content is converted within 180 days; 2) disintegration such that least 90% the material disintegrates within 40 weeks, within 30 weeks, or within 20 weeks; 3) does not contain heavy metals beyond the thresholds established under the EN12423 standard; and 4) the disintegrated content supports future plant growth as humus; where each of these four conditions are tested per the ASTM D6400, or ISO 17088, or EN 13432 method.

Compostability of the material under home composting conditions can be tested under aerobic composting conditions at ambient temperature (e.g. between 20-30° C.) according to ISO 14855-1 (2012).

Biodegradability of the material under home composting conditions can be tested according to the French norm NF T 51-800 and the Australian standard AS 5810, where a material must exhibit a biodegradation of at least 90 percent in total (e.g., as compared to the initial sample), or a biodegradation of at least 90 percent of the maximum degradation of a suitable reference material after a plateau has been reached for both the reference and test item. The maximum test duration for biodegradation under home compositing conditions is 1 year.

Similar test for determining biodegradability or compostability of a material under industrial composting conditions are well-known in the art (e.g. ISO 16929 (2013)).

In some embodiments, at least 50%, at least 60%, at least 65%, at least 70%, at least 75%, at least 80%, at least 85%, at least 90%, at least 95%, at least 97% at least 99% w/w of the article is biodegradable or compostable (e.g. soil compostable). In some embodiments, the entire article is biodegradable. In some embodiments, the entire article is compostable.

A skilled artisan will appreciate that the composting/biodegradation time period may vary depending on (i) a concentration of the thermoplastic polymer (for example, increased concentration of a polyester as the thermoplastic polymer may increase soil composting time period); (ii) physical dimensions of the article, such as wall thickness (for example, increased wall thickness will result in an increase composting/biodegradation time period). Accordingly, the inventors provide herein means for controlling composting/biodegradation of the article of the invention by varying its composition and/or dimensions (such as wall thickness).

In some embodiments, the biopolymer enhances biodegradability of the composition or article. In some embodiments, the article gradually loses it structural intactness upon contact with soil and/or water within a time period of between 2 and 15 weeks (w), between 2 and 4 w, between 4 and 6 w, between 8 and 10 w, between 10 and 15 w, between 9 and 12 w, between 12 and 15 w, including any range therebetween.

In some embodiments, at least 50%, at least 60%, at least 65%, at least 70%, at least 75%, at least 80%, at least 85%, at least 90%, at least 95% w/w of the article undergoes degradation or erosion upon contacting thereof with soil within a time period of between 2 days and 15 weeks (w), between 2 and 7 d, between 10 d and 10 w, between 5 d and 10 w, between 5 d and 5 w, between 2 and 4 w, between 4 and 6 w, between 8 and 10 w, between 10 and 15 w, between 9 and 12 w, between 12 and 15 w, including any range therebetween.

In some embodiments, the article of the invention is characterized by gradual or sustained degradation profile. In some embodiments, the article of the invention is characterized by a degradation profile adopted for cultivation of annual plants and/or perennial plants. In some embodiments, the article of the invention is configured to support growth of a young plant in a soil, thus preventing mechanical or biological damage (e.g. by a pest) to the plant roots on and post planting; and to facilitate plant roots growth (or breakthrough) through a wall of the article.

In some embodiments, the article of the invention is characterized by a predefined degradation time. In some embodiments, the degradation time is sufficient for supporting plant growth and acclimatization upon transplanting thereof into the soil. One skilled in the art will appreciate, that various plant species (such as annual, perennial plants, ornamental plant and/or trees) require different acclimatization times, accordingly the degradation time of the article is predetermined by the acclimatization time of the specific plant species. In some embodiments, the degradation time of the article of the invention can by modified by controlling the chemical composition of the article (e.g. concertation of the cured polymer, cross-linking degree, ratio between the catalyst and the curable resin in the mixture, concentration and ratios between flour and compost, and optionally the ratio between the wood residue and fluor and/or compost).

In some embodiments, at least 50%, at least 60%, at least 65%, at least 70%, at least 75%, at least 80%, of the geometrical configuration or shape of the article is retained for a time period ranging between 2 and 15 weeks (w), between 2 and 4 w, between 4 and 6 w, between 8 and 10 w, between 10 and 15 w, between 9 and 12 w, between 12 and 15 w, including any range therebetween, upon contacting thereof with soil.

In some embodiments, the article of the invention refers to a plant container comprising a cultured plant, wherein the article comprising a cultured plant is configured to substantially retain its function as a container upon contacting thereof (e.g. by transplanting) with the soil, for a time period sufficient for acclimatization of the plant within the soil (e.g. between 2 and 15 weeks, as describe hereinabove). In some embodiments, the plant container upon contacting thereof with the soil is configured to provide at least one of: (i) enclosing at least 50%, at least 60%, at least 70%, at least 80%, at least 85%, at least 90%, at least 95% of the plant roots, including any range between; (ii) providing an efficient barrier between the plant root and the soil environment sufficient for preventing damage to the plant root, wherein damage refers to a mechanical damage (e.g. during transplantation) and/or to a damage induced by a pest.

In some embodiments, the article of the invention is substantially devoid of phytotoxicity.

In some embodiments, the article of the invention is configured to support plant growth, such as under greenhouse conditions and/or under cultivation condition, such as an open field cultivation. In some embodiments, the article of the invention is characterized by any of gas permeability, water permeability, and/or permeability to plant nutrients sufficient for supporting growth of a plant (cultivated plant such as an annual plant and/or a perennial plant or tree). The exact permeability values will depend on the specific needs of the cultivated plant. In some embodiments, the article of the invention comprises at least one permeable wall, wherein the permeable wall is characterized by gas permeability, water permeability, and/or permeability to plant nutrients sufficient for supporting growth of a plant. In some embodiments, the permeable wall facilitates bidirectional water and/or plant nutrients permeation therethrough in an amount and/or rate sufficient for supporting growth of a plant.

In some embodiments, the article of the invention (e.g. a planting article) is characterized by swellability, e.g. is swellable upon contact with a liquid, such as water and/or soil. In some embodiments, the article of the invention (e.g. a planting article) is characterized by swellability upon contacting thereof with a liquid for a time period between 12 h and 7 days, between 12 h and 24 h, between 24 h and 7 days, between 24 h and 2 days, between 12 h and 3 days, between 24 h and 3 days, including any range between.

In some embodiments, the article of the invention (e.g. a food ware) is characterized by any of substantial water impermeability, substantial water repellency, substantial devoidness of water absorbance, substantial devoidness of swellability, or any combination thereof, for a time period of between 1 and 24 h, between 24 and 72 h, or more, including any range between.

As used herein the terms “water absorbance” and “swellability” refers to the ability of the article to absorb water. As used herein the terms “substantial devoidness of water absorbance” and “substantial devoidness of swellability” refer to a complete devoidness of water absorbance or to a water absorbance of at most 10%, at most 5%, at most 3%, at most 1%, at most 0.5%, at most 0.1% by weight of the article, within a time period between 1 and 24 h, between 24 and 72 h, including any range between. Water absorbance can be measured by determining the weight gain of the article upon immersing thereof in water for a predetermined time period. As used herein the term “water absorbance”, “swellability”, “substantial devoidness of water absorbance” and “substantial devoidness of swellability” encompasses water or any aqueous solution at a temperature between 1 and 70° C., between 1° and 70° C., between 1 and 50° C., including any range between.

In a further aspect of the invention, the container or article of the invention may be coated or treated with a bio-degradable coating comprising polylactic acid (PLA), or any biodegradable polymer known in the art. In some embodiments, a coating that may be used, as described in the PCT application PCT/IL2011/000739.

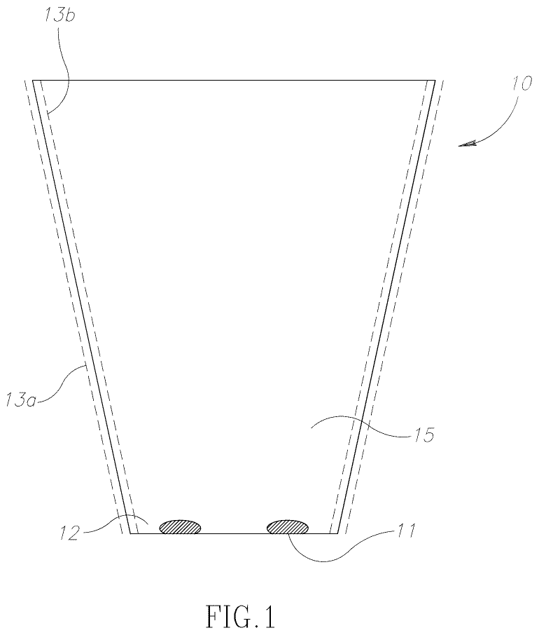

Reference is now made to FIG. 1 which schematically illustrates a plant pot according to embodiments of the invention. A (10) may include a body (15) made of the composition according to embodiments of the invention, for example, any of the mixtures described in the Examples.

A typical plant pot (10) includes drainage holes (11) in its bottom part (12). According to one embodiment the outer walls and/or inner walls of the body (15) of the plant pot (10) may be coated coating (13a and 13b correspondingly), by spraying or any other suitable method of coating. The coating (13a and 13b) may serve as a sealant to prevent early degradation of the organic mixture composing the pot.

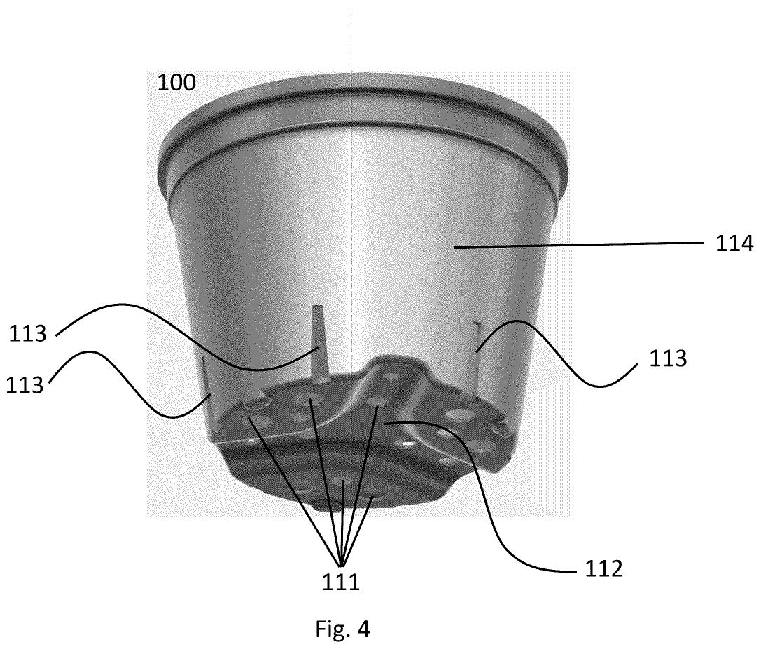

Reference is now made to FIG. 4 which schematically illustrates an exemplary article according to embodiments of the invention. A typical article (plant pot) (100) may include drainage holes (111) in its bottom part (112) as well as openings (113) in its side wall (114). In some embodiments, the opening (113) may be of any shape, such as circular shape, elliptical shape, rectangular shape, triangular shape, trapezoid shape, or a mixture of one or more shapes. In some embodiments, the opening (113) is in a form of a slit. In some embodiments, the opening (113) has an irregular shape.

In some embodiments, the typical article (plant pot) (100) may include openings (113) in its side wall (114) and is devoid of drainage holes (111) in its bottom part (112). It is presumed that the plant pot solely including openings (113) in its side wall (114) and being devoid of drainage holes (111) in its bottom part (112) will provide an improved protection from nematodes.

In some embodiments, the opening (113) is located in the side wall (114) of the exemplary article of the invention. In some embodiments, the side wall (114) comprises a single opening (113). In some embodiments, the side wall (113) comprises a plurality of openings (113), wherein plurality refers to a 1, 2, 3, 4, 5, 6, 7, 8, 9, or 10 holes. In some embodiments, the plurality of openings (113) is located at the lower part of the side wall (114). In some embodiment, the openings (113) are parallel to each other and are aligned parallel to the longitudinal axis (200).

In some embodiments, the opening (113) is characterized by a width dimension perpendicular to the longitudinal axis (200) of between 0.4 and 1 cm, 0.5 and 1 cm, 0.4 and 0.6 cm, 0.5 and 0.6 cm, 0.6 and 0.7 cm, 0.7 and 0.8 cm, 0.8 and 0.9 cm, 0.9 and 1 cm, including any range in between.

In some embodiments, the plurality of openings (113) is characterized by a length dimension parallel to the longitudinal axis (200) of between 1 and 3 cm, 1 and 1.5 cm, 1.5 and 2 cm, 2 and 2.5 cm, 2.5 and 3.0 cm, 1.25 and 1.75 cm, 1.5 and 2.5 cm, including any range in between.

In some embodiments, the openings (113) increase aeration of the plant roots and improve water drainage.

Plant pots may be manufactured in assorted sizes, for example, 5.5, 12 and 18 cm diameter, and of 3, 4, 5, 6, 7, 8 and 9 L.

In some embodiments, a pot as described herein comprises the composition of the invention and optionally a coating layer. In some embodiments, a pot as described herein consists or comprises the composition, a coating layer, and soil/compost as planting bedding. In some embodiments, a pot as described herein consists or comprises the composition, a coating layer, soil/compost, and a plant.

In some embodiments, an uncoated pot average weight is: 75.0±8.0 g. In some embodiments, an uncoated pot average weight is: 75.0±6.0 g. In some embodiments, an uncoated pot average weight is: 75.0±4.0 g. In some embodiments, an uncoated pot average weight is: 75.0±3.0 g. In another embodiment, the phrase “uncoated pot” is uncoated standard 12 cm pot. In another embodiment, a skilled artisan can readily adapt the physical properties and measures to bigger or smaller pots.

In some embodiments, the article (e.g. plant pot) of the invention is characterized by an enhanced strength as compared to any available plant pots. In some embodiments, the article (e.g. plant pot) of the invention is characterized by an enhanced strength, as compared to an article having an analogous composition and being devoid of the cured thermoset polymer. In some embodiments, the cured polymer increased mechanical strength of the article. In some embodiments, the enhanced strength of the article facilitates manufacturing of an article with a decreased wall thickness. Thus, the article comprising the composition of the invention may have a thinner wall (e.g. body and or base) without impairing the mechanical strength and/or elasticity of the article.

In some embodiments the cross-section of top portion of the article is between 8 and 15 cm, between 10 and 13, between 10 and 15 cm, including any range between. In some embodiments the cross-section of bottom portion of the article is between 3 and 8 cm, between 3 and 5, between 5 and 7 cm, between 7 and 10 cm, including any range between.

In some embodiments, the article of the invention has a body wall thickness of less than 0.4 cm, less than 0.3 cm, less than 0.2 cm, less than 0.19 cm, less than 0.18 cm, less than 0.17 cm, less than 0.16 cm, less than 0.15 cm, less than 0.13 cm, less than 0.11 cm, between 1 and 2 mm, between 1 and 1.5 mm, including any range between.

In some embodiments, the article as described herein, has a sufficient mechanical strength so as to support a plant growth. In some embodiments, the article as described herein, has a sufficient mechanical strength to facilitate automated planting.

In some embodiments, the article of the invention is particularly useful for articles or containers used in agriculture and home gardening, such as plant pots, plug trays, and any containers or receptacles of similar use including any combination thereof. In some embodiments, the article of the invention is a biodegradable and/or bioerodible article, such as planting container, a plant pots, a plant tray or any biodegradable and/or bioerodible containers or receptacles of similar use. In some embodiments, the article of the invention is shaped as food-ware.

In one exemplary embodiment, the thickness of an uncoated pot is as follows: upper rim 0.4±0.1 cm; body 0.1 to 0.15 cm; base 0.4 to 0.8 cm. In one exemplary embodiment, the thickness of an uncoated pot is as follows: upper rim 0.4±0.1 cm; body 0.1 to 0.15 cm; base 0.4 to 0.5 cm. In one exemplary embodiment, the thickness of an uncoated pot is as follows: upper rim 0.4±0.1 cm; body 0.1 to 0.15 cm; base 0.5 to 0.7 cm.

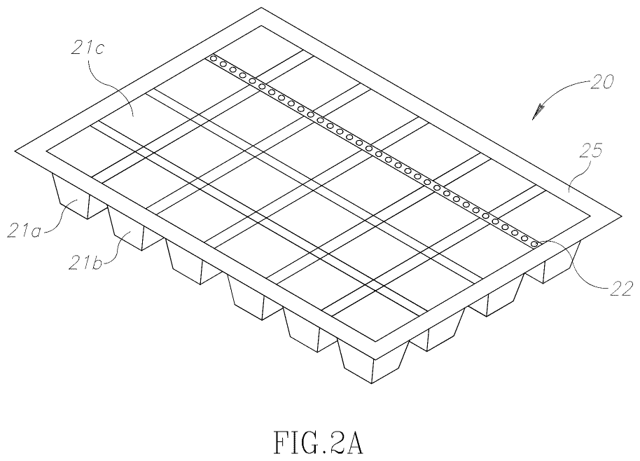

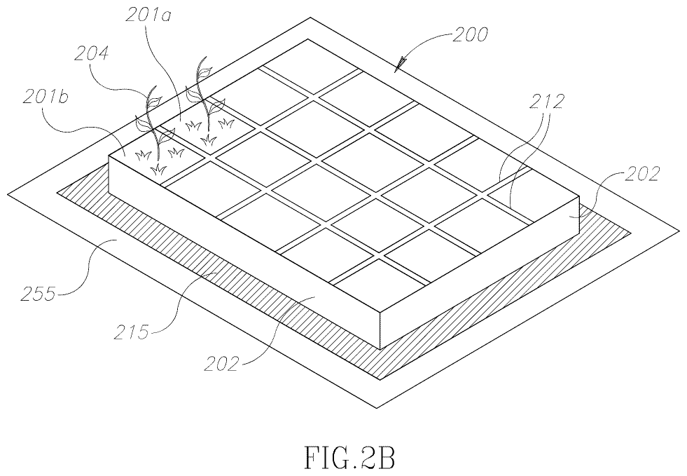

In yet a further aspect, the present invention provides a biodegradable tray for seedlings or young plants. FIG. 2A schematically illustrates a biodegradable tray according to one embodiment of the invention. The tray (20) is made of rows (and columns) of cells (21a, 21b, 21c, etc.) attached to each other or held together by a framework (25) to provide a matrix of cells. The cells (21a, 21b, 21c) are made of a biodegradable material, for example, the mixtures exemplified herein. According to some embodiments both the cells (21a, 21b, 21c) and the framework (25) are made of biodegradable material.

A tray according to embodiments of the invention may further be fully or partially coated as described in PCT/IL2011/000739 to enable “scheduled” disintegration of the biodegradable tray.

A planting tray according to another embodiment of the invention is described in FIG. 2B.

A tray (200) includes walls (202) and partitions (212) made of biodegradable material, e.g., the mixtures described herein. The tray (200) is placed within a frame construction (215) such that the walls of the construction (215) surround the tray (200). The tray within the frame construction is placed on a cutting board (255), which is typically part of an automated planting machine.

In some embodiments, the article is characterized by maximum compression load of between 100 and 5000N, between 200 and 2000N, between 100 and 2000N, between 500 and 5000N, between 500 and 2000N, between 500 and 1500N, including any range between. Compression load may be determined by a well-known compression test.

### Manufacturing Process

In another aspect, there is provided a method of manufacturing the article of the invention, the method comprises providing the composition of the invention under suitable conditions thereby obtaining a shapeable composition; and processing said shapeable composition to obtain the article of the invention, wherein the article is characterized by a predetermined shape, and wherein the composition is in a form of a mixture, or in a form of a composite, as disclosed hereinabove. In some embodiments, the method comprises providing the composition of the invention in a form of the composite (e.g. a granular composite) and shaping the composition under suitable conditions according to a predefined shape, to obtain the article of the invention.

In some embodiments, the composite is a compounded composition of the invention (powderous composition). In some embodiments, the composite is manufactured by mixing the constituents of the composition to obtain a homogenous mixture, and subsequently or simultaneously providing the homogenous mixture under conditions suitable for compounding. In some embodiments, the composite is obtained by subjecting the mixture or the entire constituents of the powderous composition under conditions suitable for hot melt processing (e.g. extrusion).

In some embodiments, the composite is manufactured by mixing (or compounding) the constituents of the composition to obtain a mixture, and extruding the mixture, thereby obtaining an extrudate. In some embodiments, mixing and hot melt processing (e.g. extruding) is performed subsequently (i.e. first mixing and then extruding) or simultaneously (e.g. within the same apparatus).

In some embodiments, shaping is by providing the composition under suitable conditions sufficient for inducing flowability or shapeability of said composition to obtain a shapeable composition; and contacting the shapeable composition with a mold. In some embodiments, the predetermines the final shape of the article. In some embodiments, the method further comprises cooling the composition within the mold, to obtain a solidified article, and further comprises releasing the solidified article from the mold. In some embodiments, shaping or processing comprises molding the composition, to obtain the article characterized by a predetermined shape.

In some embodiments, the method comprises providing the composition of the invention (i.e. the powderous composition or the composite) under suitable conditions sufficient for obtaining a processable or shapeable composition. In some embodiments, the shapeable composition is characterized by mechanical and/or rheological properties sufficient for shaping or processing thereof by means of thermoplastic polymer processing (e.g. a process selected from injection molding, extrusion, injection, hot blown film, and molding or any combination thereof). In some embodiments, the shapeable composition is pliable or deformable. In some embodiments, the shapeable composition is characterized by sufficient plasticity so as to substantially adopt the shape of the mold (e.g. by means of thermoplastic polymer processing).

In some embodiments, suitable conditions comprise a temperature above the glass transition point (Tg) of the biodegradable polymer, and pressure between 100 and 5000 bar, between 300 and 5000 bar, between 500 and 5000 bar, between 500 and 3000 bar, between 700 and 5000 bar, between 700 and 3000 bar, between 800 and 5000 bar, between 800 and 3000 bar, between 800 and 2000 bar, including any range between. In some embodiments, suitable conditions comprise a temperature of at least 10, at least 50, at least 100° C. above Tg of the biodegradable polymer including any range therebetween.

In some embodiments, suitable conditions comprise a pressure between 500 and 5000 bar, and a temperature between 100 and 200° C., between 10° and 180° C., between 120 and 200° C., between 12° and 180° C., between 140 and 200° C., between 14° and 180° C., between 120 and 170° C., between 14° and 170° C., between 16° and 170° C., including any range therebetween.

In some embodiments, the method of manufacturing the article of the invention comprises providing an amount of the composition of the invention sufficient for shaping an article with a preterminal shape and subjecting the composition under injection molding conditions. In some embodiments, the article of the invention is obtained by injection molding of a sufficient amount of the composition described herein. In some embodiments, the article of the invention is an injection molded article, comprising the composition of the invention.

The term “injection molding” as used herein also encompasses injection pressure molding.

### General

As used herein the term “about” refers to ±10%.

The terms “comprises”, “comprising”, “includes”, “including”, “having” and their conjugates mean “including but not limited to”.

The term “consisting of means “including and limited to”.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

The term “enhancing” or “reducing” is by at least 10%, at least 20%, at least 30%, at least 40%, at least 50%, at least 60%, at least 80%, at least 100%, at least 150%, at least 200%, at least 250%, at least 300%, including any range or value therebetween, compared to a control.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “substantially” refers at least 60%, at least 70%, at least 80%, at least 85%, at least 90%, at least 95%, at least 97%, at least 99%, at least 99.9%, including any rage or value therebetween. In some embodiments, the terms “substantially” and the term “consisting essentially of” are used herein interchangeably.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical, and medical arts.

As used herein, the term “treating” includes abrogating, substantially inhibiting, slowing, or reversing the progression of a condition, substantially ameliorating clinical or aesthetical symptoms of a condition, or substantially preventing the appearance of clinical or aesthetical symptoms of a condition.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments unless the embodiment is inoperative without those elements.

Various embodiments and aspects of the present invention as delineated hereinabove and as claimed in the claims section below find experimental support in the following examples. Reference is now made to the following examples, which together with the above descriptions illustrate some embodiments of the invention in a non-limiting fashion.

### EXAMPLES

Exemplary articles of the invention comprising at least one wall composed of the composition of the invention, have been fabricated by injection molding of an exemplary composition described herein. The inventors successfully manufactured the articles of the invention wither by using a powderous composition (by subjecting the powderous composition to compounding process prior to the article shaping step), or alternatively by using granules (i.e., compounded particles).

Specifically, a plant pot (diameter of ˜10.5 cm) has been successfully manufactured by injection molding, by utilizing 1-5 mm granules comprising waste particulate material (e.g. saw dust and/or compost with a particle size of about 2-3 mm) and further comprising about 25-35% of the thermoplastic biodegradable polymer (e.g. PBAT (Origo-Bi, Novamont), or Matter-Bi (Novamont)) and between about 1-7% of gliding agent (e.g. talc). The inventors further successfully manufactured articles containing up to 45% of the thermoplastic biodegradable polymer. The inventors further observed that clay mineral (e.g. talc) is superior over additional gliding agents.

The inventors postulate (based on preliminary experimental results) that the content of the biodegradable thermoplastic polymer can be reduced up to 10% w/w of the composition. A skilled artisan will appreciate that the exact fabrication conditions (injection molding parameters) may vary depending on the injection molding machine parameters and on the w/w ratio between the polymer and the waste material. Thus, the fabrication conditions can be easily adapted to a specific composition and/or specific machine by a skilled artisan.

Injection molding has been performed at a pressure of about 800 bar and a temperature ranging between 140 and 170° C. Furthermore, higher temperatures of more than 200° C. can be implemented for injection molding.

Surprisingly, the inventors found that using compost as the waste particulate material may result in the reduction of compression force need to be applied for shaping the article (e.g. by injection molding).

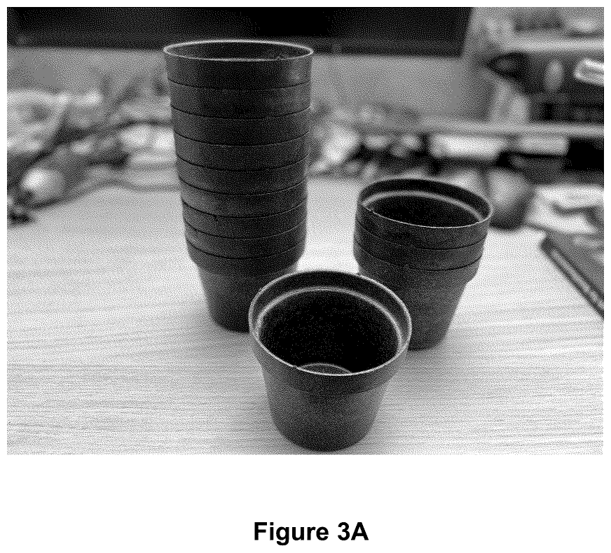

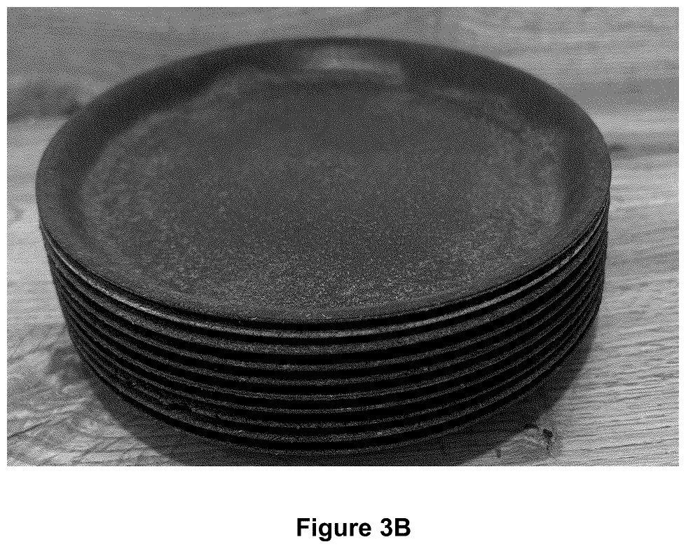

Exemplary articles are presented in FIGS. 3A-3B and 4.

Furthermore, exemplary articles (e.g. dishware) were water impermeable upon exposure thereof to water (at room temperature) for at least 12 h. The article substantially retained its shape, and no swelling has been observed.

In order to obtain preliminary degradation profile of the articles, injection molded specimens composed of the composition of the invention and having a variable content of PBAT have been buried into a soil. The physical degradation of the specimens have been visually examined after 1 month, 2 months, and 3 months. A specimen containing 10% of the biodegradable polymer resulted in a significant degradation (e.g. substantial reduction of the mechanical strength) after 2 months, and a specimen containing 20% of the biodegradable polymer resulted in a significant degradation only after 3.5 months under soil composting conditions. These results indicate that the articles of the invention are substantially biodegradable, and the degradation rate can be adjusted by varying the composition and/or dimensions of the article.

Furthermore, the inventors surprisingly observed that using compost with low residual metal content results in reduced mold abrasion upon extensive usage thereof in the manufacturing process.

The inventors tested soil compostability of the exemplary articles of the invention. In brief, two articles composed of Matter-Bi as the thermoplastic biodegradable polymer and further containing talc as the gliding agent and compost as the waste particular material have been tested. The 1st article had a wall thickness of 1.5 mm and contained 40% by weight of Matter-Bi. The 2^{nd} article had a wall thickness of 1.2 mm and contained 45% by weight of Matter-Bi. The mechanical strength of the articles before and after composting has been tested by subjecting thereof to compression force until breakage of the article.

The results of these test show that the 2^{nd} article substantially maintain their stability for a time period of at least about 7 weeks under soil composting conditions (with maximum load of about 750N, as compared to maximum load of about 880N of the initial article before composting). Furthermore, the 1^{st} article showed sufficient mechanical strength (maximum load of about 820N, which is about 60% of the maximum load of the initial article) even after 13 weeks of soil composting. After about 18 weeks of soil composting the 1^{st} article was completely disintegrated so that no reliable compression test could be performed.

1. A composition comprising a waste particulate material and a biodegradable polymer; wherein the biodegradable polymer comprises a thermoplastic polymer; a weight portion of said biodegradable polymer within said composition is between 10 and 50%; and wherein said composition is flowable at a temperature between 10° and 250° C.

2. The composition of claim 1, wherein said composition further comprises between 0.5 and 10% w/w of a gliding agent, and wherein said composition is in a form of a composite material.

3. The composition of claim 1, wherein said composition is characterized by a moisture content of less than 0.5%.

4. The composition of claim 1, wherein the biodegradable polymer is or characterized by a melt flow index (MFI) between 30 and 80.

5. The composition of claim 1, wherein the biodegradable polymer comprises a polyester, a thermoplastic starch, a thermoplastic polysaccharide derivative, including any copolymer or any mixture thereof.

6. The composition of claim 5, wherein the polyester is selected from poly(butylene adipate-co-terephthalate) (PBAT), poly(butylene succinate-co-adipate) (PBSA), PLA, PLGA, PGA, a polyaminoacid, including any copolymer or any mixture thereof.

7. The composition of claim 1, wherein the waste particulate material comprises an organic waste component selected from wood chips, soil, saw dust, compost, biomass, and ash, or any combination thereof; and wherein the waste particulate material is characterized by an average particle size between 1 and 4 mm.

8. The composition of claim 2, wherein said gliding agent comprises a clay mineral, a wax, glycerol, glycol, a fatty acid, an amino acid, a protein, including any ester thereof, or any combination thereof.

9. The composition of claim 2, wherein a weight portion of said biodegradable polymer within said composition is between 15 and 30%, a weight portion of said gliding agent within said composition is between 1 and 5%, and wherein the biodegradable polymer is or comprises said polyester.

10. The composition of claim 1, further comprises between 0.1 and 10% w/w of a water absorbing agent.

11. The composition of claim 10, wherein the water absorbing agent comprises a mono- or a di-saccharide, flour, starch, croscarmellose, crospovidone, and starch glycolate including any salt or any combination thereof.

12. The composition of claim 1, wherein said composition is selected from: (i) a composition shapeable under conditions suitable for injection molding; (ii) a composition in a form of granules characterized by an average size of between 1 and 10 mm; (iii) a composition being a thermoplastic material.

13. (canceled)

14. (canceled)

15. An article comprising at least one wall, wherein the at least one wall comprises the composition of claim 1, and wherein the article is compostable.

16. The article of claim 15, wherein the article is soil compostable within a predetermined time period ranging between 2 days and 20 weeks.

17. The article of claim 15, wherein said wall is characterized by a wall thickness of between 1 and 5 mm.

18. The article of claim 15, wherein said article is in a form of a container, a planting article, or a dishware.

19. (canceled)

20. The article of claim 15, wherein said article is stable under greenhouse conditions for a predefined time period ranging between 3 days and 10 months, optionally wherein said article is characterized by (i) gas permeability; and by (ii) at least partial water impermeability.

21. (canceled)

22. A method of manufacturing a compostable article, the method comprises providing the composition of claim 1 under conditions sufficient for inducing flowability of said composition, thereby obtaining a shapeable composition; and processing said shapeable composition to obtain the article with a predetermined shape, wherein said processing comprises molding of said shapeable composition.

23. (canceled)

24. (canceled)

25. The method of claim 22, wherein the suitable conditions comprise a pressure between 500 and 5000 bar, and a temperature between 10° and 250° C.

26. The method of claim 22, wherein said method is performed by injection molding.
